(19) United States
(12) Patent Application Publication
(10) Pub. No.: US 2014/0319201 A1
(43) Pub. Date: Oct. 30, 2014

(54) Display Cardboard Folded Package with Periphery Sealed Edges

(71) Applicant: Moshe Yair Begim, East Rancho Dominguez, CA (US)

(72) Inventor: Moshe Yair Begim, East Rancho Dominguez, CA (US)

(21) Appl. No.: 13/869,867

(22) Filed: Apr. 24, 2013

(51) Int. Cl. B65D 5/42; B31B 1/26; B31B 1/88

(52) U.S. Cl. CPC B65D 5/4212; B31B 1/88; B31B 1/26; B31B 2201/88; B31B 2201/26
USPC 229/5.81; 493/55

(57) ABSTRACT

A package for a product includes a single sheet having one side with an image of the product printed on it, and blank on the opposing side. The sheet is foldable into a shell having a rear opening, and the shell is sized to receive the product through the opening. The shell has a front panel bearing an image of the product. The sheet further includes a top panel adjacent to the shell, and a rear panel to cover the rear opening. The shell has outer edges adhered to outer edges of the rear panel, so that the product may be placed inside the shell and thereby sealed inside the package. The package has crushed edges around a majority of the perimeter of the package, including preferably between the shell and the rear panel.

This application claims the benefit of the priority date of provisional application No. 61/638,156, filed on Apr. 25, 2012.

### BACKGROUND

Blister packaging for small electronics goods is well known. One type of such display packaging consists of a pair of corrugated cardboard sheets joined together with a clear PVC plastic insert showing the product, and is popular with manufacturers and consumers. Consumers can sec the product when contemplating a purchase, and for manufacturers the double cardboard layer package is rugged for protecting the product during shipping, and the sealed edges provide tamper resistance. See, for example, Nazari, U.S. Pat. No. 7,726,480.

There are environmental concerns with this popular type of packaging, however, as the cardboard and plastic portions are individually recyclable but must be separated for recycling. Even if designed to be separable, most consumers fail to make the effort. This is because the packaging is typically difficult to open and so consumers resort to using a knife or scissors to cut the plastic portion and extract the product, leaving the plastic and cardboard together upon disposal. Accordingly, a better package is needed for displaying the product in a tamperproof fashion and that is environmentally friendly, as well as inexpensive to make.

Another issue with blister packaging for consumer products, having two sheets of corrugated cardboard and a clear plastic container sandwiched between them, is that this type of conventional packaging uses hot melt glue typically applied by hand and difficult to control due to the drying time and placement of the glue. Also, the corrugated sheets of the cardboard are visible on the side edges of the finished packaging which is aesthetically unappealing.

Other conventional blister packaging uses one sheet of corrugated cardboard and one or two flat sheet of paper, adhered together by adhesive. Since only one cardboard sheet is used, this type of packaging sometimes lacks sufficient structural strength when multiple display packs are stood on their sides in a container. When the weight of the top package is supported directly by the packs in the bottom bundle, they must have sufficient structural strength and rigidity to prevent them from bending.

### SUMMARY

A package for a product includes a single sheet having one side with an image of the product printed thereon and an opposing blank side. The sheet is foldable into a shell having a rear opening, and the shell is sized to receive the product inside the shell through the opening. The shell has a front panel with an image of the product. The sheet further includes a top panel next to the shell, a rear panel to cover the shell, and the shell has outer edges adhered to outer edges of the rear panel, so that the product may be placed inside the shell and is sealed inside the package. The package has crushed edges around a majority of the perimeter of the package.

In various embodiments, the rear panel may extend to cover the top panel. The sheet is preferably made of corrugated cardboard, including a cut-out in the top panel corresponding to a cut-out the rear panel, for forming a handle for the package. Preferably the sheet includes a crushed area between the outer edges of the shell and the outer edges of the rear panel.

To create the shell, the foldable sheet includes a first set of opposing side panels and a second set of opposing side panels adjoining a front panel, the front panel bearing an image of the product. The second set of opposing side panels includes tabs disposed distally from the front panel, and when the sheet is folded such that the tabs and the top panel align with the rear panel to form a common peripheral edge, an enclosure for the product is formed.

To form the package, a single sheet of foldable material is provided and an image of the product printed on only one side of the sheet. The sheet is folded to create a shell sized to hold the product and a top panel, and folded to create a rear panel for enclosing the shell and covering the top panel. The outer edges of the rear panel are adhered to corresponding outer edges of the top panel and the outer edges of the shell, and the outer edges are crushed. A product may be inserted into the shell prior to the adhering the outer edges together, and adhesive may be applied between the rear panel and the top panel inward of the outer edges. To form a handle for hanging or carrying, holes may be formed in the top panel and correspondingly through the rear panel.

### BRIEF DESCRIPTION OF THE FIGURES

FIG. 1 is a plan view, flat pattern of the printed side of a cardboard sheet.

FIG. 2 is a perspective view of the blank side of the cardboard sheet.

FIG. 3 is a perspective view of the cardboard sheet folded into a package.

FIG. 4 is a partial cross-section view through the side of the package.

### REFERENCE NUMERALS

10. Package
12. Foldable Sheet
14. Graphic Representation of a Product
18. Tabs
20. Cut-Out Portion
22. Printed Side
24. Top Panel
26. Front Panel
28. First Side Panel
30. Second Side Panel
32. Third Side Panel
34. Fourth Side Panel
36. Flap
40. Indented Fold Lines
44. Rear Panel
50. Blank Side
52. Peripheral Edge
54. Crushed Area

### DESCRIPTION

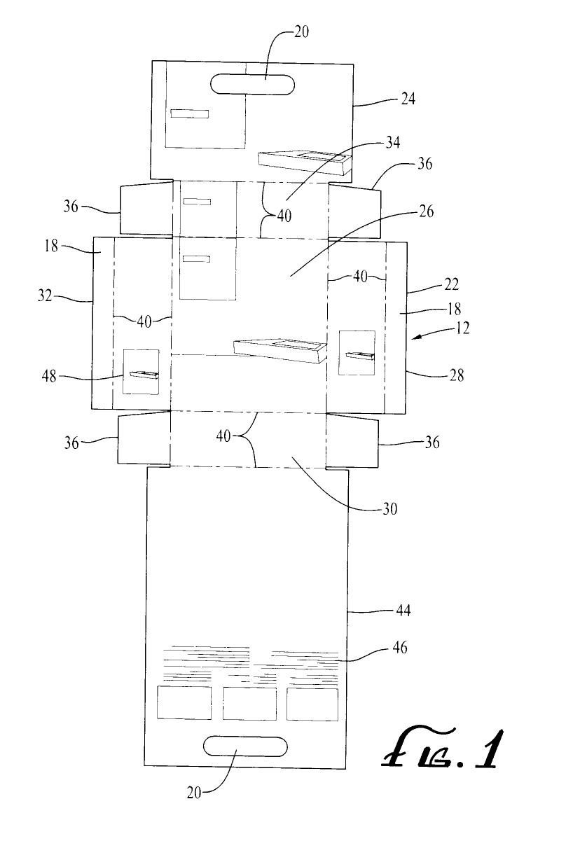

FIG. 1 is a plan view of a foldable sheet 12, showing the printed side 22 of the foldable sheet. The foldable sheet 12, which is preferably made of cardboard, but may be made of any substantially flat foldable material, includes a front panel 26 and four side panels 28, 30, 32 and 34, referred to as first through fourth side panels, respectively. Flaps 36 are attached to the four side panels 28, 30, 32 and 34 to prevent gaps when the foldable sheet 12 is folded. In the illustrated embodiment, four side flaps 36 are attached to opposite ends of the second side panel 30 and fourth side panel 34, which are themselves on opposite sides of the front panel 26. In other embodiments, the flaps 36 may be disposed on opposite sides of the first side panel 28 and third side panel 32. or a single flap 36 may be disposed on each of the four side panels 28, 30, 32 and 34 as desired.

Still referring to FIG. 1, the first side panel 28 and third side panel 32 each have a tab 18 affixed opposite the front panel 26. The second side panel 30 has a rear panel 44 affixed opposite the front panel 26. and the fourth side panel 34 has a top panel 24 affixed opposite the front panel 26. Preferably, the foldable sheet 12 may be creased, or otherwise constructed such that the front panel 26, side panels 28, 30, 32 and 34, flaps 36, tabs 18, rear panel 44 and top panel 24 tend to fold along predetermined indented fold lines 40, which govern the shape of a package (not shown) formed from the foldable sheet 12.

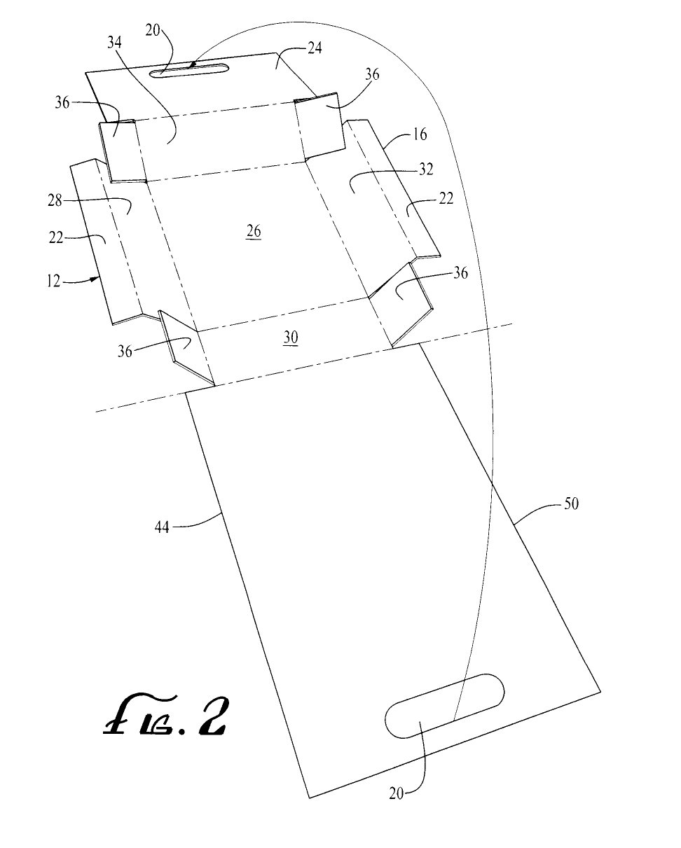

FIG. 2 shows a perspective view of the blank side 50 of the foldable sheet 12 in preparation for folding. In order to form a package (not shown), the side panels 28, 30, 32 and 34 are folded relative to the front panel 26 to have a shell-like appearance, with the flaps 36 folded inward of the side panels 28, 30, 32 and 34, as shown. The rear panel 44 may then be folded over to engage the tabs 18 and top panel 24. In this manner, the blank side 50 of the foldable sheet 12 always forms the interior of a package (not shown), while the printed side 22 of the foldable sheet 12 always forms the exterior of a package.

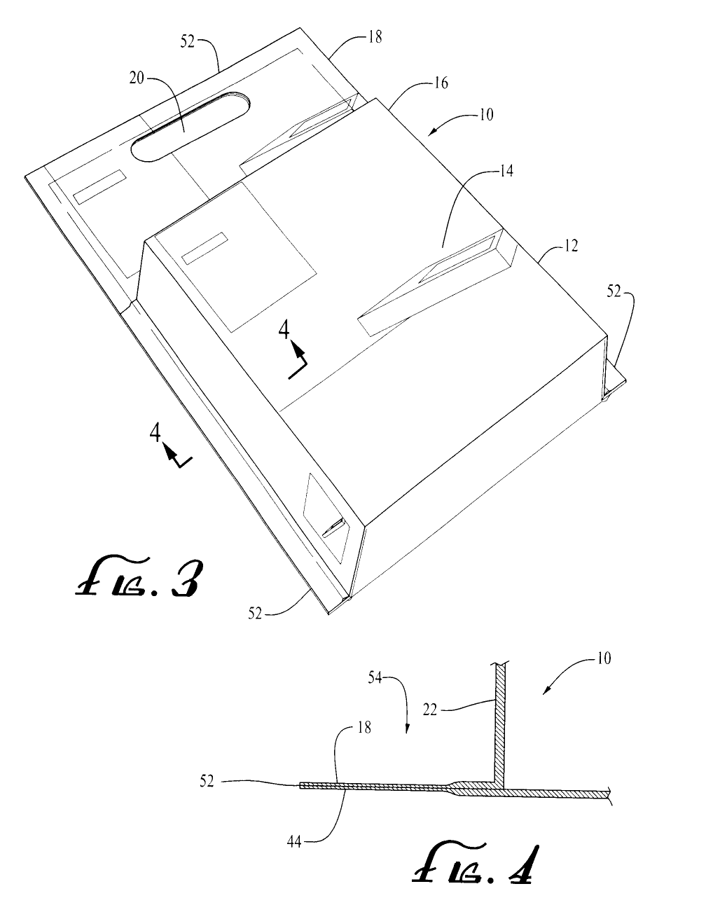

FIG. 3 is a perspective view of the foldable sheet 12 fully assembled into a sealed package 10 with a graphic representation of a product 14. When the foldable sheet 12 is folded together to form a package 10, the shell-like structure formed by the front panel 26, side panels 28, 30, 32 and 34, the tabs 18 and the top panel 24 form a uniform peripheral edge 52. The peripheral edge 52 may be characterized as an area extending from the extreme edge of the foldable sheet 12 approximately a half an inch inward from the extreme edge. Additionally, cut-out portions 20 on the sheet 12 (shown in FIGS. 1 and 2) may align to form a handle for hanging or carrying the package 10. Since the printed side 22 of the sheet 12 is on the exterior of the package 10, it may show graphics 14, including images of items enclosed by the package 10.

FIG. 4 shows a cross section view through the side of the package 10 of FIG. 3. Once a product (not shown) is packaged inside an assembled package 10, a crushed area 54 may be formed inward of the peripheral edge 52. The crushed area 54 may comprise an adhesive (not shown) to facilitate sealing of the package 10, and the adhesive may also extend beyond the crushed area 54 depending on the amount of adhesion desired. By heat seal coating the crushed area 54 prior to applying heat and pressure, the peripheral edge 52 may sealed to provide a tamper-resistant package 10 along with an attractive peripheral edge 52 of minimal thickness.

Typically adhesive (not shown) should be strong enough so the package 38 will stay sealed in transit and while hanging on a peg (not shown), but weak enough so that it can be opened by a consumer. Additionally, a variety of sealants are contemplated, including heat seal, cold seal, glue, etc. Preferably, the foldable sheet 10 is entirely made of recyclable and recycled cardboard. With a graphic 14, including a photograph or image of the product printed on the package 10, customers can see what they're buying before the purchase occurs.

The foregoing description of the preferred embodiment of the invention is sufficient in detail to enable one skilled in the art to make and use the invention. It is understood, however, that the detail of the preferred embodiment presented is not intended to limit the scope of the invention, in as much as equivalents thereof and other modifications which come within the scope of the invention as defined by the claims will become apparent to those skilled in the art upon reading this specification.

What is claimed is:

1. A package for a product comprising:
a single sheet having one side with an image of the product printed thereon and an opposing blank side;
the sheet foldable into a shell having a rear opening, the shell sized to receive the product therein through the opening;
the shell having a front panel bearing an image of the product;
the sheet further having a top panel adjacent to the shell;
a rear panel for covering the rear opening;
the shell having outer edges adhered to outer edges of the rear panel, such that the product may be placed inside the shell and thereby sealed inside the package; and
the package having the outer edges crushed around a majority of the perimeter of the package.

2. The package of claim 1 wherein the rear panel extends to cover the top panel.

3. The package of claim 1 wherein the sheet is made of corrugated cardboard.

4. The package of claim 1 wherein the sheet includes a cut-out in the top panel corresponding to a cut-out the rear panel, for forming a handle for the package.

5. The package of claim 1 wherein the outer edges between the shell and the rear panel are crushed.

6. A one piece blank for forming a package for a product comprising:
a foldable sheet having a printed side and a blank side;
the foldable sheet further comprising a shell having a first set of opposing side panels and a second set of opposing side panels adjoining a front panel, the front bearing an image of the product;
the second set of opposing side panels having tabs disposed distally from the front panel; and
wherein when the sheet is folded such that the tabs and the top panel align with the rear panel to form a common peripheral edge. an enclosure for the product is formed.

7. A method of forming a package for displaying a product comprising the steps of:
providing a single sheet of foldable material;
printing an image of the product on only one side of the sheet;
folding the sheet to create a shell sized to hold the product and a top panel;
folding the sheet to create a rear panel for enclosing the shell and covering the top panel;
adhering outer edges of the rear panel to corresponding outer edges of the top panel and the outer edges of the shell; and
crushing the outer edges.

8. The method of claim 7 including the step of inserting the product into the shell prior to the adhering of the outer edges together.

9. The method of claim 7 including the step of applying adhesive between the rear panel and the top panel inward of the outer edges.

10. The method of claim 7 including the step of forming holes in the top panel and through the rear panel to create a handle.
